(19) United States
(12) Patent Application Publication
(10) Pub. No.: US 2010/0251603 A1
(43) Pub. Date: Oct. 7, 2010

(54) Succinimide Detergent Containing One Basic Secondary Amine and a Hydrocarbyl-Substituted Succinic Group and a Fuel Composition Containing Such

(75) Inventors: Mark C. Davies, Derby (GB); David J. Moreton, Derbyshire (GB)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: The Lubrizol Corporation

(21) Appl. No.: 12/681,896

(22) PCT Filed: Oct. 23, 2008
(86) PCT No.: PCT/US08/80858

§ 371 Date: May 17, 2010

(30) Foreign Application Priority Data
Oct. 26, 2007 (US) 60982767

(51) Int. Cl. C10L 1/232; C08F 136/06

(52) U.S. Cl. 44/347; 548/540

(57) ABSTRACT

Succinimide dispersant produced by reacting a hydrocarbyl-substituted succinic anhydride and an amine having at least one primary amino group and at least one secondary amino group where the succinimide detergents are useful as additives in fuels.

### BACKGROUND OF THE INVENTION

Hydrocarbon fuels generally contain substances that tend to form deposits in the fuel delivery system of an internal combustion engine such as the fuel injectors in diesel engines and the intake valves in gasoline engines. These deposits, if allowed to build up, can significantly reduce engine performance in terms of drivability, power output, fuel economy and exhaust emissions. It is highly desirable to incorporate detergents into hydrocarbon fuels that are effective in controlling deposits by inhibiting their formation and facilitating their removal so that engine performance is maintained or improved.

U.S. Pat. No. 6,210,452 B1, Su, Apr. 3, 2001 discloses fuel additives to control the formation of deposits in internal combustion engines, which comprise carboxylic acid alkoxylates suited for use with nitrogen containing fuel detergents.

International Publication WO 98/12282 A1 discloses a detergent additive composition for diesel fuel that contains a polyisobutylene monosuccinimide in an aromatic hydrocarbon diluent. The detergent additive composition can be used to remove or prevent engine deposits.

The next generation of diesel engines are direct injection engines, where the diesel fuel is directly injected into the combustion chamber using electronic ignition which allows for multiple injections. The injection is now done at much higher pressures which enhance the fuel spray. The injector holes and shape are also changing to make them more efficient in the drive towards lower emissions. In these new engines, not only are the tolerances less, but there is more thermal stress on the fuel both in the overall fuel system and at the injector tip. With all of these changes, OEMs are promoting an increased use of diesel detergents.

The most common diesel engine detergents are based on polyisobutylene (PIB) succinimdes where the polar basic head group formed by the aminic function of the detergent is adsorbed onto the carbonaceous deposit and the deposit is dispersed by the long hydrocarbon (PIB) chain in the fuel. These detergents also perform a cleaning function that involves the polar head of the detergent adsorbing to the metal surface of the injector forming a protective layer so that carbonaceous deposits are minimized. Traditional succinimide detergents use heavy polyalkylene amines such as tetraethylene pentamine (TEPA) as the amine, the perceived wisdom being that the high basicity (high TBN) afforded by the heavy polyamine is important for deposit control and antifouling performance. These products are primarily monosuccinimides, that is they contain only one succinimide group per molecule, and while they do offer the required performance, they have a number of problems associated with their use of the heavy polyamine. These problems include higher viscosities that can make material handling more difficult. There can also be a tendency for the viscosity of such materials to increase over time. Oil is often added to compositions with such problems, resulting in less concentrated and so less efficient additives.

There is a need for a detergent that provides improved deposit control and antifouling performance, material handling properties or combinations thereof.

### SUMMARY OF THE INVENTION

The invention of a new succinimide detergent, and its use in a fuel, provides consistent to improved antifouling performance compared to the traditional succinimide detergent and promotes easier handling and processing because no oil is needed in the final additive concentrate and there is no viscosity increase during storage. The invention solves the problems encountered with the use of heavy polyamines and heavy polyamine derived succinimides, providing at least equivalent performance while allowing for more concentrated additive blends and reduced processing, handling, and storage issues.

The invention provides for a fuel composition comprising, (a) a fuel, which is liquid at room temperature, and (b) a succinimide detergent comprising the reaction product of: (i) a hydrocarbyl-substituted succinic anhydride, and (ii) an amine having one primary amino group and one secondary amino group having a hydrocarbyl substituent. In one embodiment of the invention, the hydrocarbyl substituent of the secondary amino group of the amine, is a methyl group.

The invention also provides for a fuel additive composition comprising a succinimide detergent comprising: (i) the reaction product of a hydrocarbyl-substituted succinic anhydride, and (ii) an amine having one primary amino group and one secondary amino group having a hydrocarbyl substituent that is a methyl group or a hydrocarbyl group with a methyl branch.

The invention also provides for a method of fueling an internal combustion engine comprising the steps of supplying to said engine the fuel compositions and/or the fuel additive compositions described both above and below.

### DETAILED DESCRIPTION OF THE INVENTION

Various preferred features and embodiments will be described below by way of non-limiting illustration.

### Fuel

The fuel composition of the invention comprises a fuel which is liquid at room temperature and is useful in fueling an engine. The fuel is normally a liquid at ambient conditions, e.g., room temperature (20 to 30° C.). The fuel can be a hydrocarbon fuel, a nonhydrocarbon fuel, or a mixture thereof. The hydrocarbon fuel can be a petroleum distillate to include a gasoline as defined by ASTM specification D4814 or a diesel fuel as defined by ASTM specification D975. In an embodiment of the invention the fuel is a gasoline, and in other embodiments the fuel is a leaded gasoline, or a nonleaded gasoline. In another embodiment of this invention the fuel is a diesel fuel.

The hydrocarbon fuel can be a hydrocarbon prepared by a gas to liquid process to include for example hydrocarbons prepared by a process such as the Fischer-Tropsch process. The nonhydrocarbon fuel can be an oxygen containing composition, often referred to as an oxygenate, which can include an alcohol, an ether, a ketone, an ester of a carboxylic acid, a nitroalkane, or a mixture thereof. The nonhydrocarbon fuel can include for example methanol, ethanol, methyl t-butyl ether, methyl ethyl ketone, transesterified oils and/or fats from plants and animals such as rapeseed methyl ester and soybean methyl ester, and nitromethane. Mixtures of hydrocarbon and nonhydrocarbon fuels can include, for example, gasoline and methanol and/or ethanol, diesel fuel and ethanol, and diesel fuel and a transesterified plant oil such as rapeseed methyl ester.

When the fuel is a diesel fuel, the diesel fuel can be a hydrocarbon fuel that includes middle distillate fuels obtained from the refining of a petroleum or mineral oil source and fuels from a synthetic process such as a Fischer-Tropsch fuel from a Fischer-Tropsch process. Middle distillate fuels generally have a distillation temperature range of 121 to 371° C., which is greater than that of gasoline or naphtha with some overlap. Middle distillate fuels include distillation fractions for diesel, jet, heating oil, gas oil, and kerosene. The diesel fuel can be a biodiesel fuel. Biodiesel fuels can be derived from animal fats and/or vegetable oils to include biomass sources such as plant seeds as described in U.S. Pat. No. 6,166,231. Biodiesel fuels include esters of naturally occurring fatty acids such as the methyl ester of rapeseed oil which can generally be prepared by transesterifying a triglyceride of a natural fat or oil with an aliphatic alcohol having 1 to 10 carbon atoms. In one embodiment of the invention the fuel is a diesel fuel which comprises a middle distillate fuel, a Fischer-Tropsch fuel, a biodiesel fuel, or mixtures thereof. A mixture can be, for example, a mixture of one or more distillate fuels and one or more biodiesel fuels or a mixture of two or more biodiesel fuels. Middle distillate fuels generally contain aromatic hydrocarbons, which tend to be a source of atmospheric pollution. Middle distillate fuels can contain very high levels of aromatic hydrocarbons near 85% by volume or very low levels of aromatic hydrocarbons near 3% by volume when highly refined to meet environmental regulations and in other instances can contain aromatic hydrocarbons from 3 to 60% by volume and from 3 to 40% by volume. In one embodiment of the invention the liquid fuel is an emulsion of water in a hydrocarbon fuel, a nonhydrocarbon fuel, or a mixture thereof. In several embodiments of this invention the fuel can have a sulfur content on a weight basis that is 5000 ppm or less, 1000 ppm or less, 300 ppm or less, 200 ppm or less, 30 ppm or less, or 10 ppm or less.

The fuel can be present in the fuel composition in an amount that is generally greater than 50 percent by weight, and in other embodiments is present at greater than 90 percent by weight, greater than 95 percent by weight, greater than 99.5 percent by weight, or greater than 99.8 percent by weight.

### Succinimide Detergent

Succinimide detergents are well known in the fuels field and include primarily what are sometimes referred to as “ashless” detergents because they do not contain ash-forming metals and they do not normally contribute any ash forming metals when added to a fuel. Succinimide detergents are the reaction product of a hydrocarbyl substituted succinic acylating agent and an amine containing at least one hydrogen attached to a nitrogen atom. The term “succinic acylating agent” refers to a hydrocarbon-substituted succinic acid or succinic acid-producing compound (which term also encompasses the acid itself). Such materials typically include hydrocarbyl-substituted succinic acids, anhydrides, esters, including half esters, and halides.

Succinic based detergents have a wide variety of chemical structures including typically structures such as:

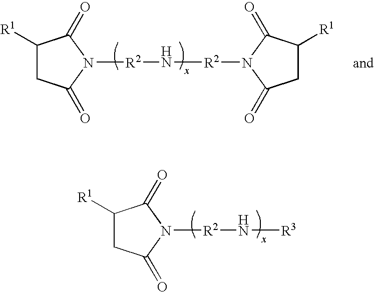

wherein each R¹ is independently a hydrocarbyl group which may be bound to multiple succinimide groups; each R² is independently an alkylene group such as ethylene or methylene; R³ is hydrogen, a hydrocarbyl group, or an alkyl group such as methyl or ethyl; and x can be 1-10, 1-5, and in some embodiments 1. The hydrocarbyl group of R¹ can be a polyolefin-derived group having a number average molecular weight of 500 to 10,000 or 700 to 10,000. In one embodiment the hydrocarbyl group is an alkyl group, such as a polyisobutylene group, with a molecular weight of 500 to 5000, or 700 to 5000, or 1500 to 5000, or 2000 to 5000. Alternatively expressed, each R¹ group can contain 40 to 500 carbon atoms or at least 50 to 300 carbon atoms, e.g., aliphatic carbon atoms. Various modes of attachment of the R¹ groups, including various cyclic structures, are contemplated. The alkylene groups of R² are commonly derived from the reaction of an alkenyl acylating agent with a polyamine, and a wide variety of linkages between the two moieties are possible beside the simple imide structure shown above, including a variety of amides and quaternary ammonium salts. Succinimide detergents are more fully described in U.S. Pat. Nos. 4,234,435, 3,172,892, and 6,165,235.

The polyalkenes from which the R¹ substituent groups are derived are typically homopolymers and interpolymers of polymerizable olefin monomers of 2 to 16 carbon atoms. In one embodiment of the invention the polymerizable olefin monomers have 2 to 6 carbon atoms. The olefin monomers from which the polyalkenes are derived are polymerizable olefin monomers characterized by the presence of one or more ethylenically unsaturated groups (i.e., >C═C<); that is, they are mono-olefinic monomers such as ethylene, propylene, 1-butene, isobutene, and 1-octene or polyolefinic monomers (usually diolefinic monomers) such as 1,3-butadiene, and isoprene. These olefin monomers are usually polymerizable terminal olefins; that is, olefins characterized by the presence in their structure of the group >C═CH₂. Relatively small amounts of non-hydrocarbon substituents can be included in the polyolefin, provided that such substituents do not substantially interfere with formation of the substituted succinic acid acylating agents.

The hydrocarbyl substituted succinic acylating agent from which the succinic detergent is derived is not particularly limited so long as it conforms to the characteristic described above for the resulting succinic detergent. Generally the succinic acylating agents suitable for use in the invention can be represented by structures such as:

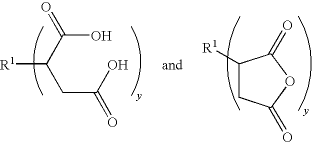

wherein R¹ is as defined above, and y represents the molar average number of such succinic groups attached to the R¹ groups. In one type of detergent, y=1. In another type of detergent, y is greater than 1, in one embodiment greater than 1.3 or greater than 1.4; and in another embodiment y is equal to or greater than 1.5. In one embodiment y is 1.4 to 3.5, such as 1.5 to 3.5 or 1.5 to 2.5. Fractional values of y can arise because y is a molar average and different specific R¹ chains may be reacted with different numbers of succinic groups.

In one embodiment of the invention the hydrocarbyl-substituted succinic anhydride can be a polyisobutylene succinimide where the polyisobutylene substituent has a molecular weight between 350 to 5000.

The amines from which the succinic detergent is derived include alkylene amines conforming, for the most part, to the formula

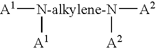

wherein each A¹ and A² is independently hydrogen or a hydrocarbyl group, and the alkylene group is an alkylene group having less than 30 carbon atoms. In one embodiment of the invention, the amine contains one, and only one, primary amino group and one, and only one, secondary amino group, that is, both A¹ groups are hydrogen (the primary amino group) and only one A² group is hydrogen while the other A² group is a hydrocarbyl group (the secondary amino group). In one embodiment, where one or more of the A¹ and A² groups is a hydrocarbyl group, the hydrocarbyl groups can have up to 30 carbon atoms. In another embodiment both A¹ groups and one A² group are hydrogen while the other A² group is a methyl group. In another embodiment, the alkylene group connecting the two amino groups can contain 8 or less carbon atoms.

The alkylene amines suitable in the invention include ethylene diamines, propylene diamines, decamethylene diamines, and octamethylene diamines. Ethylene diamines are particularly useful and are described in some detail under the heading “Ethylene Amines” in Encyclopedia of Chemical Technology, Kirk and Othmer, Vol. 5, pp. 898-905, Interscience Publishers, New York (1950).

In one embodiment the hydrocarbyl substituent of the secondary amino group of the diamine (the non-hydrogen A² group in the formula above) may be a methyl group. In one embodiment of the invention the amine can be 2-methylaminoethylamine (also known as N-methylethylenediamine), 3-methylaminopropylamine, 4-methylaminobutylamine, or combinations thereof.

The succinimide detergent is referred to as such since it normally contains nitrogen in the form of imide functionality, although it may be in the form of amine salts, amides, imidazolines as well as mixtures thereof. To prepare the succinimide detergent, one or more of the succinic acid-producing compounds and one or more of the amines are heated, typically with removal of water, optionally in the presence of a normally liquid, substantially inert organic liquid solvent/diluent at an elevated temperature, generally in the range of 80° C. up to the decomposition point of the mixture or the product; typically 100° C. to 300° C.

The succinic acylating agent and the amine can be reacted in amounts sufficient to provide at least one-half equivalent, per equivalent of acid-producing compound, of the amine. In one embodiment, the maximum amount of amine present will be 2 moles of amine per equivalent of succinic acylating agent. For the purposes of this invention, an equivalent of the amine is that amount of the amine corresponding to the total weight of amine divided by the total number of nitrogen atoms present. The number of equivalents of succinic acid-producing compound will vary with the number of succinic groups present therein, and generally, there are two equivalents of acylating reagent for each succinic group in the acylating reagents. Additional details and examples of the procedures for preparing the succinimide detergents of the invention are included in, for example, U.S. Pat. Nos. 3,172,892; 3,219,666; 3,272,746; 4,234,435; 6,440,905 and 6,165,235.

In one embodiment of the invention, the hydrocarbyl-substituted succinic anhydride can be a polyisobutylene succinimide where the polyisobutylene substituent has a molecular weight between 350 to 5000, the amine can be 3-methylaminopropylamine, and the resulting succinimide detergent can be 3-polyisobutenyl-N-(3-methylaminopropyl) succinimide.

In one embodiment of the invention, the fuel composition and the fuel additive composition may also comprise additional fuel additives. These fuel additives can comprise an antioxidant; a friction modifier selected from the group consisting of an alkoxylated fatty amine, a fatty acid or derivative thereof, and mixtures thereof; an additional detergent; and mixtures thereof.

### INDUSTRIAL APPLICATION

In one embodiment the invention is useful as an additive in a liquid fuel for an internal combustion engine. In another embodiment the invention is useful in a method of operating an internal combustion engine. The internal combustion engines suitable for use with this invention include a 2-stroke or 4-stroke engine fueled with gasoline, diesel, a natural gas or a mixed gasoline/alcohol fuel. Suitable diesel engines include both light duty and heavy duty diesel engines and direct injection diesel engine. Suitable gasoline engines include direct injection gasoline engine.

In one embodiment the succinimide detergent can be present in the fuel additive composition from 10 to 10000 ppm. In another embodiment from 15 to 5000 ppm, from 20 to 1000 ppm, from 25 to 500 ppm, from 30 to 200 ppm, from 50 to 75 ppm.

### Miscellaneous

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include: hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring); substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy); hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the invention in its intended use, may not be susceptible of easy description. Nevertheless, all such modifications and reaction products are included within the scope of the invention; the invention encompasses the composition prepared by admixing the components described above.

### EXAMPLES

The invention will be further illustrated by the following examples, which sets forth particularly advantageous embodiments. While the examples are provided to illustrate the invention, they are not intended to limit it.

### Preparative Example 1

The PIBSA material for use in the preparation of the other examples described below is Preparative Example 2 of patent application WO 2006/063161 A2, and is the reaction product of polyisobutylene polymer with maleic anhydride.

### Preparative Example 2

The PIBSA material for use in the preparation of the other examples described below is Comparative Preparative Example 1 of patent application WO 2006/063161 A2, and is the reaction product of polyisobutylene polymer with maleic anhydride.

### Example 1

Example 1 is made in a 1 liter flange flask. 400 g of the product of Preparative Example 1 and 60 g of a commercially available zero aromatic low pour point base oil are introduced into the flask along with a nitrogen inlet and a stirrer, with stirrer guide are added to the flask. The flask is also equipped with a pressure equalizing funnel with subsurface addition tube and a Dean Stark trap, with water condenser on top, placed in the spare port. A nitrogen blanket is switched on and the contents of the flask are stirred at ˜150 rpm. The contents are warmed to 110° C. and stirrer speed increased to ˜300 rpm. 37.3 grams of N-methyl-1,3-diaminopropane are charged to the pressure equalizing funnel and the amine added drop wise over 50 minutes. After the addition of amine, 10 grams of the oil are charged to the dropping funnel and added to the reaction helping to wash in any residual amine. The nitrogen inlet is placed on top of the addition funnel and the tap opened. A slow nitrogen flow is turned on to help push any remaining oil/amine out of the sub-surface tube. Then, the stirrer is stopped in order to remove the addition funnel and subsurface. The stirrer is restarted and the reactor is then heated up to 175° C. over one hour, then left during 4 hours at this temperature. During this hold, water of reaction is collected in the Dean Stark trap. During the entire reaction, FTIR spectra are taken every hour to allow the progress of the reaction to be monitored via Imide/Amide/Salt formation. After the hold time the reaction is cooled to below 100° C. and discharged.

### Comparative Example 1

Comparative Example 1 is prepared by stirring 1366 g of the product of Preparative Example 1 into 134 g of a commercially available zero aromatic low pour point base oil in a vessel to form a mixture. The mixture is then filtered through a Celite pad under vacuum. The mixture is then heated to 110° C. and stirred at 300 rpm under nitrogen. 36.1 g of tetraethylene pentamine is added dropwise over 30 minutes before heating the vessel to 175° C. and held for 4 hours. The vessel was then cooled to provide a product with a Kinematic Viscosity at 100° C. of 482 mm/s (cSt); a TBN of 72 and a nitrogen content of 3.66 wt %. The final product has 73 wt % polyisobutylene succinimide and 27 wt % base oil and a nitrogen to carbonyl ratio of 1.8:1.

### Comparative Example 2

Comparative Example 2 is prepared using 35560 Kg of the product of Preparative Example 2, adding a commercially available base oil with a high viscosity index to and further placing in a vessel purged with nitrogen. The vessel is heated to 110° C. and 3777 Kg of tetraethylene pentamine added over 3 hours with the temperature varying from 110° C. to 120° C. throughout the addition. The vessel is then heated to 150° C. for 4 hours and further purged with nitrogen for 1 hour. The vessel is then heated to 175° C. and held for 4 hours. After cooling the final product has a nitrogen to carbonyl ratio of 2.24:1, a Kinematic Viscosity at 100° C. of 495 mm/s (cSt) and a TBN of 79. The amount of base oil present is enough to provide a final product with 60 wt % succinimide and 40 wt % base oil.

The detergents described above are evaluated in the XUD-9 engine nozzle fouling test, as described in CEC F-23-01. A detergent passes the test if shows any percentage of flow remaining. The percentages of remaining flow of various materials can be used to compare the materials' deposit control and antifouling performance.

TABLE 1
XUD-9 Engine Nozzle Fouling Test Results

| | Treat | Lifter 1 | Lifter 2 | Lifter 3 | Lifter 4 | Average | Average |
|---|---|---|---|---|---|---|---|
| | Rate | Blockage | Blockage | Blockage | Blockage | Blockage | Remaining |
| | ppm | % | % | % | % | % | Flow % |
| Comparative | 45 | 79 | 76 | 65 | 59 | 70 | 30 |
| Example 1 | | | | | | | |
| Comparative | 60 | 81 | 78 | 60 | 67 | 72 | 28 |
| Example 2 | | | | | | | |
| Example 1 | 45 | 40 | 53 | 35 | 31 | 40 | 60 |

The results of the testing show that a formulation using the succinimide detergents (Example 1) of the invention shows superior flow performance and less average blockage of an injection compared to formulations using typical polyalkylene amine-derived succinimides of the types found commercially (Comparative Examples 1 and 2). The results show that the invention has improved deposit control and antifouling performance. Comparative Example 1 uses the same PIBSA material, diluted to the same amount, as Example 1. The improved performance of Example 1 over Comparative Example 1 shows one benefit of the present invention.

The materials are also evaluated by measuring their initial viscosity at 100 degrees Celsius by ASTM D445. The lower the viscosity, the less handling problems the material will have.

TABLE 2
D445 100° C. Viscosity Test Results

| | | Kinematic |
|---|---|---|
| | Actives | Viscosity |
| | Level | mm²/s (cSt) |
| Comparative | 85% | 717 |
| Example 1 | | |
| Example 1 | 85% | 187 |

The results of the testing show that succinimide detergents of the invention (Example 1) show decreased viscosity compared to typical heavy polyalkylene-derived succinimides of the types available commercially (Comparative Example 1). The results show that the invention has improved material handling properties. Again, Comparative Example 1 uses the same PIBSA material, diluted to the same amount, as Example 1. The lower viscosity of Example 1 over Comparative Example 1 shows one benefit of the present invention.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined with one another. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

What is claimed:

1. A fuel composition comprising,
(a) a fuel, which is liquid at room temperature; and
(b) a succinimide detergent comprising the reaction product of:
(i) a hydrocarbyl-substituted succinic anhydride, and
(ii) an amine having one primary amino group and one secondary amino group having a hydrocarbyl substituent.

2. The fuel composition of claim 1, wherein the hydrocarbyl substituent of the secondary amino group of (b)(ii), the amine, is a methyl group.

3. The fuel composition of claim 2, wherein (b)(ii), the amine, is 2-methylaminoethylamine, 3-methylaminopropylamine, 4-methylaminobutylamine, or combinations thereof.

4. The fuel composition of claim 1, wherein (b) is present in an amount of 10 ppm to 10000 ppm.

5. The fuel composition of claim 1, wherein (b)(i), the hydrocarbyl-substituted succinic anhydride, is a polyisobutylene succinimide where the polyisobutylene substituent has a number average molecular weight between 350 to 5000.

6. The fuel additive composition of claim 1, wherein (b), the succinimide detergent, is 3-polyisobutenyl-N-(3-methylaminopropyl) succinimide.

7. The fuel composition of claim 1, wherein the fuel is diesel fuel.

8. A fuel additive composition comprising a succinimide detergent comprising the reaction product of:
(i) a hydrocarbyl-substituted succinic anhydride; and
(ii) an amine having one primary amino group and one secondary amino group having a hydrocarbyl substituent that is a methyl group.

9. A method of fueling an internal combustion engine comprising:
I. supplying to said engine, (a) a fuel which is a liquid at room temperature, and (b) a succinimide detergent comprising the reaction product of:
(i) a hydrocarbyl-substituted succinic anhydride, and
(ii) an amine having one primary amino group and one secondary amino group having a hydrocarbyl substituent.
